(19) United States
(12) Patent Application Publication
(10) Pub. No.: US 2015/0074824 A1
(43) Pub. Date: Mar. 12, 2015

(54) SECURE DATA STORAGE APPARATUS AND SECURE IO APPARATUS

(71) Applicants: REXEON TECHNOLOGY CORPORATION, Nagoya-shi (JP); NATIONAL INSTITUTE OF ADVANCED INDUSTRIAL SCIENCE AND TECHNOLOGY, Tokyo (JP)

(72) Inventors: Kenji TODA, Tsukuba-shi (JP); Kenji SAYANO, Tsukuba-shi (JP)

(73) Assignees: REXEON TECHNOLOGY CORPORATION, Nagoya-shi (JP); NATIONAL INSTITUTE OF ADVANCED INDUSTRIAL SCIENCE AND TECHNOLOGY, Tokyo (JP)

(21) Appl. No.: 14/199,226

(22) Filed: Mar. 6, 2014

(30) Foreign Application Priority Data
Sep. 6, 2013 (JP) 2013-185766

(51) Int. Cl. G06F 21/62

(52) U.S. Cl. CPC G06F 21/62
USPC 726/28

(57) ABSTRACT

A secure data storage apparatus capable of independently holding security information within a hardware device of the storage apparatus, and of implementing write prohibition and read prohibition of data is provided. As means for specifying security such as write prohibition/write inquiry/read prohibition/read inquiry for data of a given size or a given number of pieces of data, a storage component for holding security information is prepared in addition to a storage component for holding data. For each unit of storage of the storage component for holding data, corresponding security data is held in the storage component for holding security information. In this way, in response to occurrence of a request to access data, security information corresponding to a storage area for holding the data is referred to, and an operation is performed in accordance with the security information.

### BACKGROUND OF THE INVENTION

### Field of the Invention

The present invention relates to a secure data storage apparatus and a secure IO apparatus.

Write prohibition and read prohibition of data are generally implemented by software such as the OS or application program. However, because various vulnerabilities exist in complicated software, malware may enter from a network and infect the software. Consequently, the case where unauthorized data access is overlooked often occurs.

Hardware data protection means is implemented by a write prohibition switch which is attached to an SD card, floppy disk, encased magnetic tape medium, or the like. Also, apparatuses that prohibit writing when being connected to a hard disk are commercially available. However, these means each prohibit writing on a medium-by-medium basis. However, these means are unable to prohibit writing, to prohibit reading, and to request the user for access permission for a given number of pieces of data or data of a given size. Also, apparatuses that perform processing of secure data in cooperation with various IO ports as well as a storage are not yet commercially available.

### NON-PATENT REFERENCES

[Non-patent Reference 1] Brian Carrier: File System Forensic Analysis, Addison Wesley Professional, ISBN: 0-32-126817-2, Mar. 17, 2005.
[Non-patent Reference 2] Hirokazu Takahashi and Kazuto Miyoshi, “Linux Kernel 2.4 no Sekkei to Jissou 6 Fairu Shisutemu (Zenpen) (The Design and Implementation of Linux Kernel 2.4 6 File System (First part)),” Linux Japan, pp. 171-196, April 2001.
[Non-patent Reference 3] Hirokazu Takahashi and Kazuto Miyoshi, “Linux Kernel 2.4 no Sekkei to Jissou 7 Fairu Shisutemu (Kouhen) (The Design and Implementation of Linux Kernel 2.4 7 File System (Latter part),” Linux Japan, pp. 139-164, May 2001.

### SUMMARY OF THE INVENTION

A protection-function-equipped storage apparatus is implemented which is capable of specifying security such as write prohibition/write inquiry/read prohibition/read inquiry for data of a given size or a given number of pieces of data and which makes it impossible for the OS or application program that utilizes the storage apparatus to perform control such as changing of protection-target data, changing of protected content, or on/off of the protection function.

A display, touch panel, or the like can also be prepared separately from an ordinary PC in order to implement an access violation notification and an access permission inquiry to the user; however, this makes the apparatus larger and makes it difficult to downsize the apparatus.

The present invention has been proposed in view of the issues described above. Specifically, an object is to provide a secure data storage apparatus capable of independently holding security information within a hardware apparatus of the storage apparatus and of implementing write prohibition and read prohibition of data.

To achieve the aforementioned object, a secure data storage apparatus according to the present invention is characterized in that the secure data storage apparatus is capable of setting a specified data area to be a write-prohibited data area, and in a case where there is a write request for the write-prohibited data area, does not perform writing in the area, and that information about the request is recorded and a user is notified that the request has been prohibited.

The secure data storage apparatus according to the present invention is characterized in that the secure data storage apparatus is capable of setting a specified data area to be a read-prohibited data area, and in a case where there is a read request for the read-prohibited data area, does not perform reading in the area, and that dummy data is returned, information about the request is recorded, and a user is notified that the request has been prohibited.

The secure data storage apparatus according to the present invention is characterized in that the secure data storage apparatus is capable of setting a specified data area to be subjected to a write inquiry or read inquiry, and has a function of making an inquiry to a user as to whether or not to permit writing or reading in a case where there is a write request or read request for the data area, and of performing writing or reading only in a case where permission is returned.

The secure data storage apparatus according to the present invention includes, as means for specifying security of write prohibition/write inquiry/read prohibition/read inquiry for a given number of storage areas or a storage area of a given size, a storage component for holding security information in addition to a storage component for holding data, and is characterized in that, for each unit of storage of the storage component for holding data, corresponding security information is held in the storage component for holding security information, and in a case where a request to access the data occurs, the secure data storage apparatus refers to the security information corresponding to a storage area for storing the data and operates in accordance with the security information.

The secure data storage apparatus according to the present invention is characterized in that the storage component for holding data is also used as the storage component for holding security information, a portion of a storage area of the storage component for holding data is an area that is not used as a data area and is invisible from an OS or application program on a PC, and the security information is held in the area.

A secure IO apparatus according to the present invention is characterized in that various IO ports are directly controlled by hardware so that the control is not sensed from an OS or application program on a PC and IO of data is performed in a secure manner.

The secure data storage apparatus and the secure IO apparatus according to the present invention are configured in the above-described manner. With this configuration, security information can be independently held within a hardware apparatus of the storage apparatus and write prohibition and read prohibition of data can be implemented. Also, because the protection function cannot be controlled from the OS or application program at all, the data is secure.

### BRIEF DESCRIPTION OF THE DRAWINGS

FIG. 1 A diagram illustrating a first embodiment of a secure data storage apparatus according to an embodiment of the present invention.

FIG. 2 A diagram illustrating a second embodiment of the secure data storage apparatus according to the embodiment of the present invention.

FIG. 3 A diagram illustrating the overview of a conventional control system.

FIG. 4 A diagram illustrating the secure data storage apparatus according to the embodiment of the present invention and issues of the control system.

FIG. 5 A diagram illustrating a connection form of the secure data storage apparatus according to the embodiment of the present invention.

FIG. 6 A conceptual diagram of enhancement of communication security by the secure data storage apparatus according to the embodiment of the present invention.

FIG. 7 A conceptual diagram of enhancement of data access security by the secure data storage apparatus according to the embodiment of the present invention.

FIG. 8 A diagram illustrating an example of access control performed by the secure data storage apparatus according to the embodiment of the present invention in an EXT2 file system.

FIG. 9 A diagram illustrating connections between the secure data storage apparatus according to the embodiment of the present invention and protection-target devices.

FIG. 10 A diagram illustrating the configuration of a security tag in the secure data storage apparatus according to the embodiment of the present invention.

### DESCRIPTION OF THE PREFERRED EMBODIMENTS

Next, embodiments of the present invention will be described based on the drawings.

### Introduction

Present major social infrastructures such as production systems of factories, plants, or the like, railway/traffic systems, wireless communication networks for mobile phones or the like, various information services such as computer networks or clouds using the networks are constructed on a foundation of control systems. Hitherto, damage has often been caused by phishing, computer viruses, cyber-attacks, and so on, and measures thereagainst have been taken in information systems. However, attacks on control systems of factories, communication networks, and so on have rarely occurred, and measures against such attacks have not been considered to be important. A reason for this is that attacks on control systems are hardly related to personal profits. Also, another reason is that, because many control systems have adopted their unique OS or their unique communication protocols, all tools for the attack are not available and it is difficult to make an attack readily.

However, the presence of malware called Stuxnet, which had kept many centrifuges used for uranium enrichment out of order in a certain nuclear facility for a long time, has been revealed, and vulnerabilities of industrial control devices have been recognized. This is a serious threat to the social infrastructures such those of industry, military, transport, and electric power. In Japan, attacks by malware have been discovered, and it has become an urgent necessity to take measures against them.

<Characteristics of Control System>

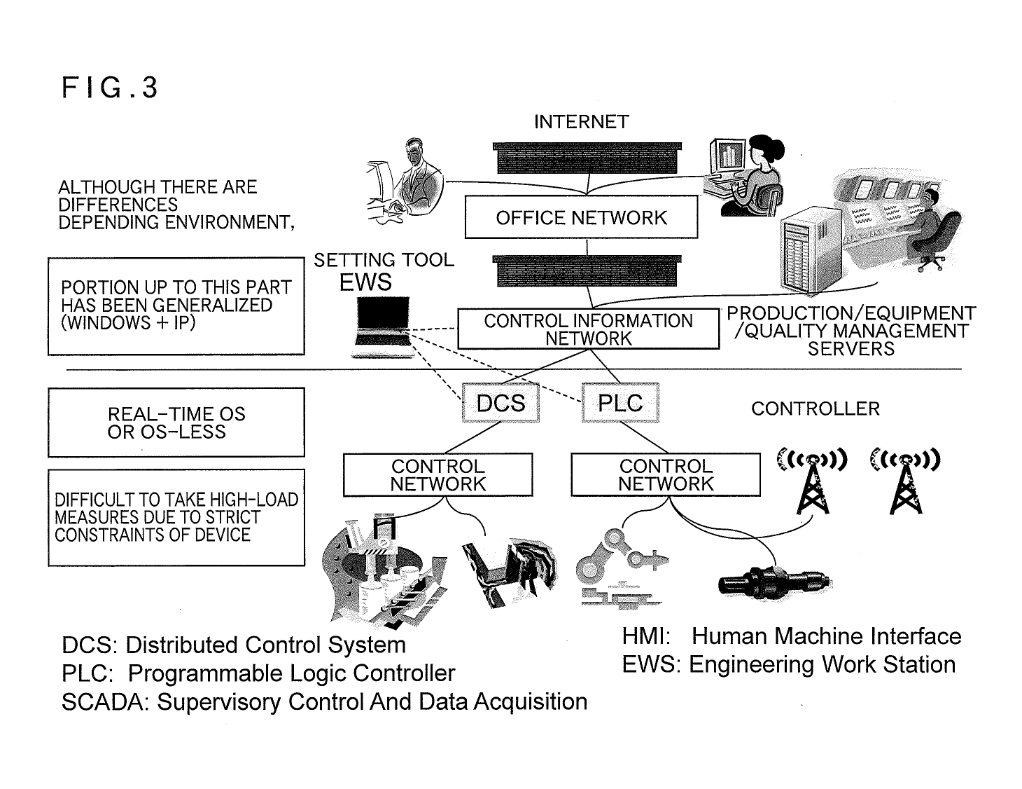

A general configuration of a control system is illustrated in FIG. 3. Specifically, devices that perform physical control at a factory or plant are connected to a DCS (Distributed Control System) and a PLC (Programmable Logic Controller) that control the devices using control networks. At a higher layer thereof, an engineering PC used to perform programming in the DCS and the PLC using a control information network is connected. At a higher layer thereof, office PCs or the like are connected via a firewall. The office PCs are connected to the external Internet via a higher-layer firewall.

In order to improve security of the control system, security measures for these control-information-network devices are mainly needed. Characteristics of the control-information-network devices are as follows:

Importance is placed on availability (operation should not be stopped)

Importance is placed on response time (real-time processing)

Processing requiring a heavy load is difficult (because of resources of the devices or real-time processing)

Update of a program is difficult (because of availability, real-time processing, and resources)

The devices are used for a long time (10 years to 20 years)

A unique OS or a unique protocol is used

A general-purpose PC or open standard is adopted in the controller.

Damage caused at the time of a system failure is large

The devices may be subjected to highly targeted attacks

Malware may break into the control network constituted by the PLC (Programmable Logic Controller), the engineering PC through which programming is performed in the PLC, and the like from an external network or USB memory that is connected for maintenance or the like. Nevertheless, vulnerabilities such as backdoors, insufficient encryption or authentication, or weak passwords have been found in PLCs in Japan, the United States, and Europe, and it has become an urgent necessity to take measures against them (US ICS-CERT and IPA, “Alerts on vulnerabilities of control devices”, Feb. 29, 2012). However, to take actions against vulnerabilities by updating the OS or application program of the device constituting the control network is not easy because of the device's limited processing ability and a difficulty in verification of operation of the already-installed control system. The threats of highly targeted attacks on control systems, notably the one by Stuxnet, are increasing, and measures against attacks, such as zero-day attacks, to vulnerabilities that are yet to be dealt with are also desired.

The present invention that solves the issues described above provides an apparatus (add-on apparatus for security=security barrier device (SBD)) that is easily applicable to existing control systems. The SBD is connected to devices on the control network and interconnects IO ports of the devices, whereby any extra load is not put on the devices and the performance is maintained. The SBD is a hardware device that serves as a security protective barrier that overcomes the vulnerabilities described above.

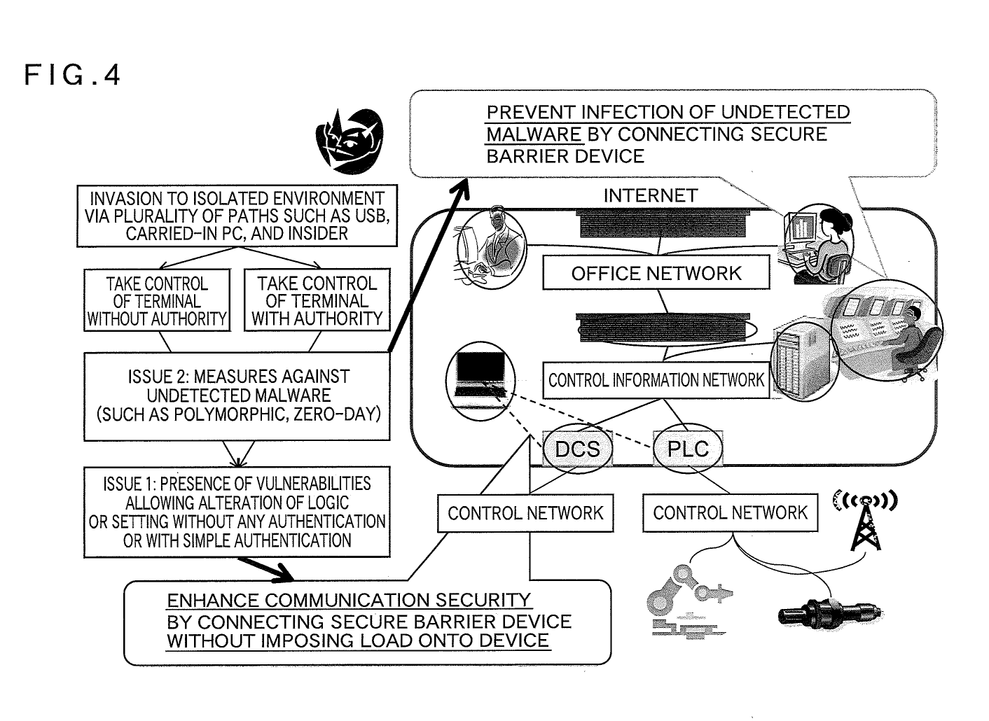

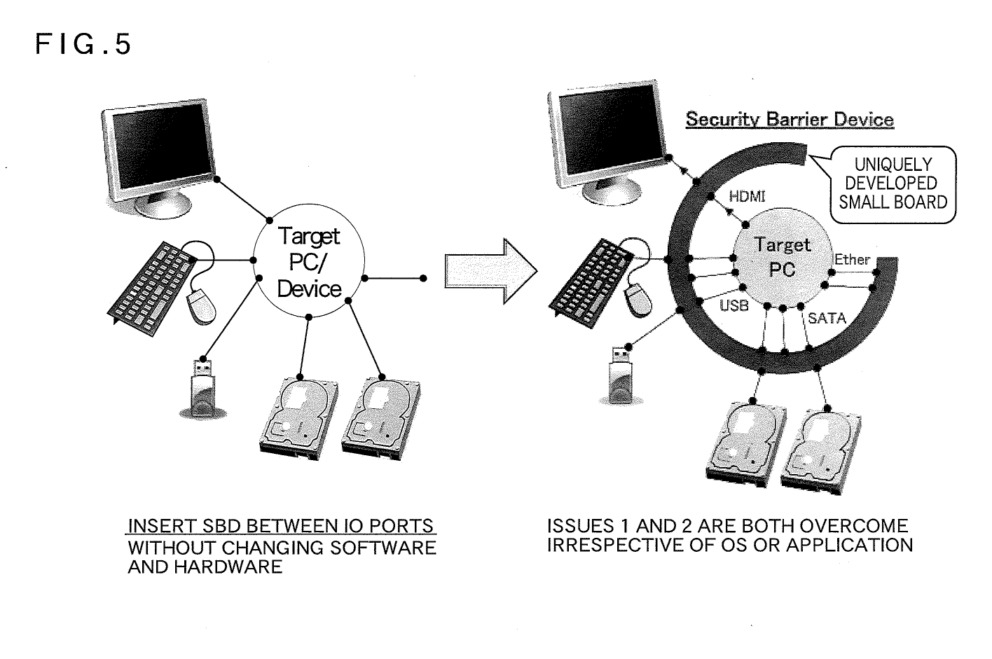

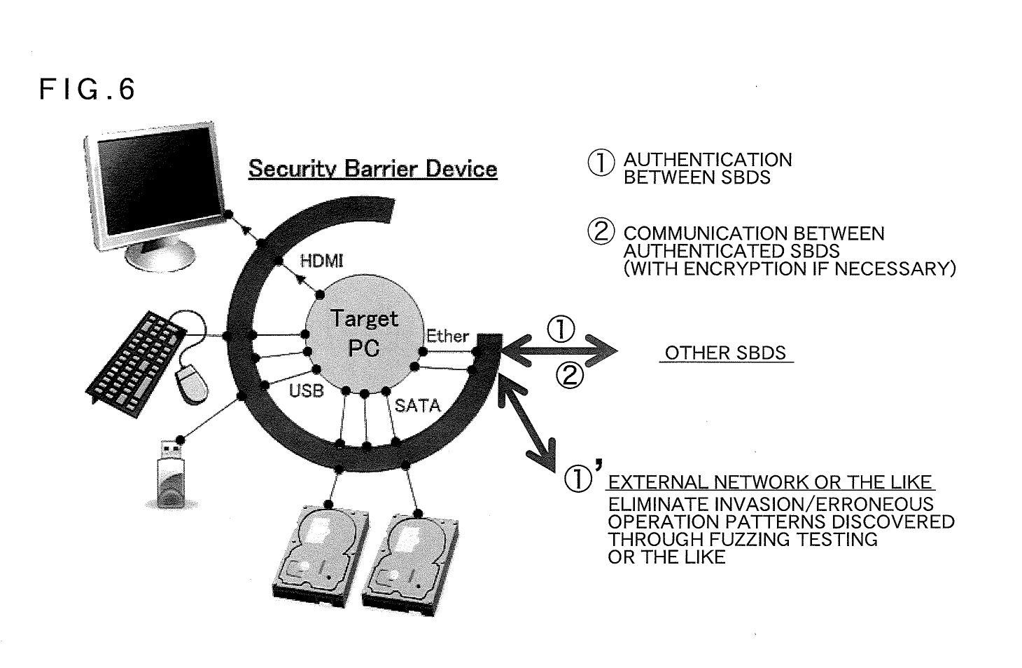

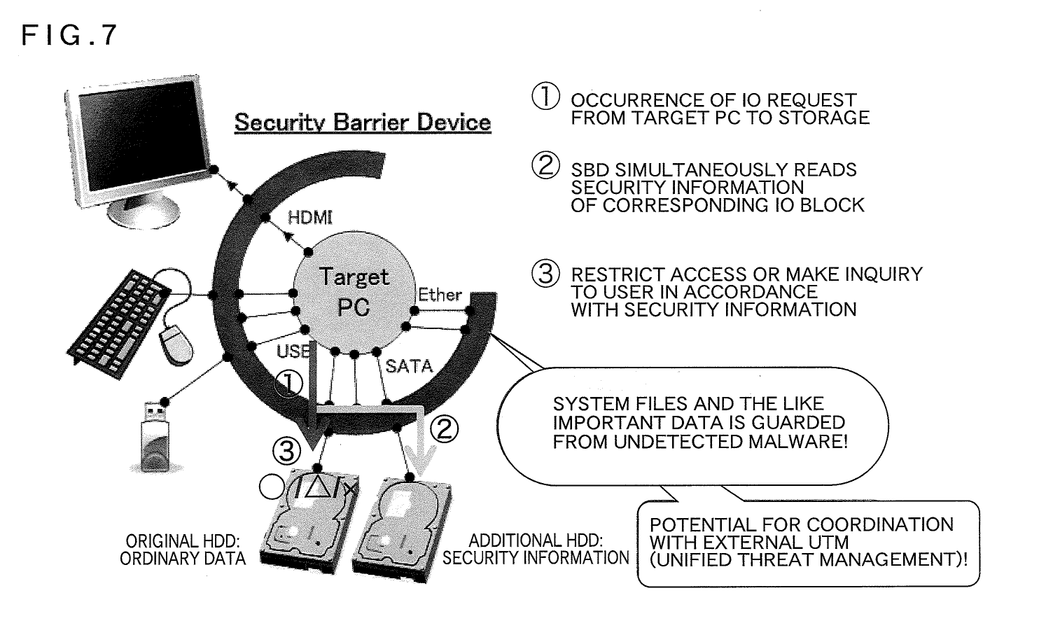

The SBD can be connected to the PLC and the engineering PC through which programming is performed in the PLC without installation of software regardless of whether the software is the OS or application program, and interconnects IO ports based on Ethernet, USB, SATA, HDMI, or the like. At interconnections of IO ports, security of communication is enhanced using authentication and encryption, and access to important files stored in a USB or SATA storage is recorded or controlled. The SBD has a function for requesting the user to make a confirmation via a display, keyboard, or the like when needed. These functions of the SBD can prevent unauthorized apparatuses from being connected to the control network. Also, the SBD has a function for preventing malware from infecting authorized apparatuses and for enhancing security of the control network (see FIG. 4). How the SBD is connected to a protection-target PC and devices is illustrated in FIG. 5. As for enhancement of communication security, authentication is performed between the attached SBDs and encrypted communication is performed between the SBDs if necessary, whereby the protection-target devices communicate with each other as illustrated in FIG. 6. It is also possible to filter communication patterns that cause invasion and erroneous operations and that are determined through fuzzing testing (means for supplying the system with unexpected inputs so as to discover vulnerabilities of the system), using the SBD. As for enhancement of data access security, in addition to the original storage, a dedicated storage that stores security information (which is an implementation example and need not be an independent device) is added as illustrated in FIG. 7. In response to occurrence of an IO from the protection-target device to the original storage, the SBD reads out security information of an IO block corresponding to the additional storage (invisible from the protection-target apparatus). The SBD has a function for restricting access (such as prohibiting reading and prohibiting writing) or making an inquiry to the user in accordance with the security information. This function is implemented by the SBD independently of the protection-target device. For this reason, this function is not detected by the malware, and can prevent information breaches or rewriting of important information by malware. Accordingly, it is considered that targeted attacks for sufficiently collecting information on the attack target and zero-day attacks for attacking vulnerabilities that are yet to be dealt with can be addressed. Note that what is provided by the SBD is access control to the storage, and thus the following needs to be considered for a file system in which data is cached in a memory.

<Access Control in Units of Areas>

An HDD/SSD/USB memory or the like is assumed as the storage device. All of these are block devices, and their unit of access is 512 B which is the ATA sector size. Accordingly, by providing access control information on a sector-by-sector basis (in an additional disk or the like as described before), access control in units of sectors is implemented. Therefore, access control in units of partitions of a disk is easily implemented, and adjustment at the OS side at that time involves a few issues. Data or system files that should not be rewritten are collected in a write-prohibited partition, or data that should not usually be read out is collected in a read-prohibited partition. If there is unauthorized access to these partitions, such access is detected, and a log is recorded by the SBD and is utilized to detect an unauthorized operation or malware.

<Overview of Access Control in Units of Files>

The aforementioned access control in units of areas requires organization of data on a partition-by-partition basis. In contrast, if access control in units of files can be done, the original storage can be made secure without any additional processing. Control devices based on the EXT series (such as Linux), the NTFS (such as Windows series, USB memory), and the FAT series (such as old Windows, MS-DOS, VxWorks, USB memory) are mainly used. Among these, devices based on the EXT2, the NTFS, and the FAT32 are dominant. The SBD aims to support these control devices.

All of these control devices have a tree directory structure, and a file is composed of a directory entry and a data block. The data block is larger than the sector in size. Accordingly, access control involves no problem. On the other hand, the directory entry (and a data structure involving it) is smaller than the sector in size, and thus the resolution of access control needs to be improved.

An improvement in the resolution of access control is implemented in the following procedure. Specifically, in this procedure, a required resolution is recorded in security information corresponding to a sector having been read, and access control information is read out in unit of the resolution (if the access control information cannot be stored in the additional disk without any processing, the access control information may be developed separately in another area). When the sector is written in the storage, processing of access control is performed in unit of the resolution (specifically, in the case of write prohibition, writing is performed using the data portion read out from the storage so as not to change the data stored in the sector).

As for write prohibition of a file, write prohibition needs to be set also for the path (route) from the root. This is because a file can be uniquely identified only when the path is included.

<Example of Access Control in EXT2 File System>

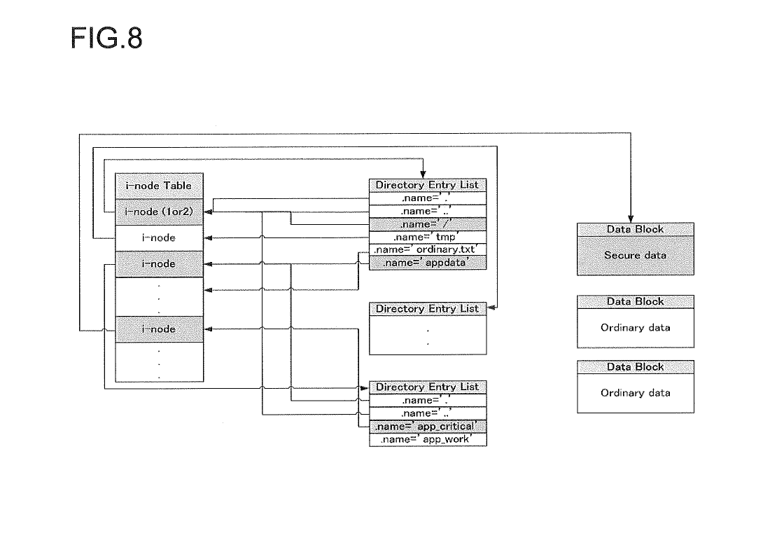

An example of access control performed by the SBD in EXT2 is illustrated in FIG. 8. In the figure, suppose that a file “app_critical” is write-prohibited. The SBD needs to set write prohibition also for data of the path name “/appdata/app_critical” from the root, which is illustrated in red in the figure.

<Considerations on Effective Access Control by SBD>

In the case of file access, the OS performs access control using a file attribute, it is not so difficult to modify the OS to receive access control information of a file from the storage device, and it is considered that this is one direction of making the OS more secure. Simpler measures will do for a simple OS which does not perform caching to a memory and reading of a bitmap.

Possible operations in file access control performed by the SBD device without modifying the OS irrespective of the sophistication level of the OS are summarized below.

[Bottom line]: (The OS of the protection-target device is not affected)

It is possible to notify the system administrator of occurrence of a prohibited access operation via the SBD.

Means for disconnecting the network in the case of occurrence of access control violation is prepared.

(Applications) A log regarding all IO ports is recorded in response to access control violation, and this record can be used to detect malware, determine the infection path, and so on.

[In the case of read prohibition]:

A dummy value is returned.

The OS at least does not operate erroneously if the name of a read-prohibited file within a directory is correctly shown and data is set to be a dummy value.

The name of a read-prohibited file within a directory is not displayed. Likewise, the OS does not operate erroneously.

If a read-prohibition bit is set (that is, access to a directory is prohibited), file names and pointers other than those of the target and its parent are not shown when a directory is accessed.

An IO error is returned. The OS may handle the error as a sector error.

No IO is returned. The storage device may be unmounted or the OS may freeze.

[In the case of write prohibition]:

Successful writing is returned. Inconsistency between data in the memory and data in the storage may occur, and consequently the issues described before may occur.

An IO error is returned. The OS may handle the error as a sector error.

No IO error is returned. The storage device may be unmounted or the OS may freeze.

There may be circumstances where freezing would be preferably permitted rather than have malware taking control of the engineering PC through which programming is performed in the PLC or the like.

<Configuration of SBD>

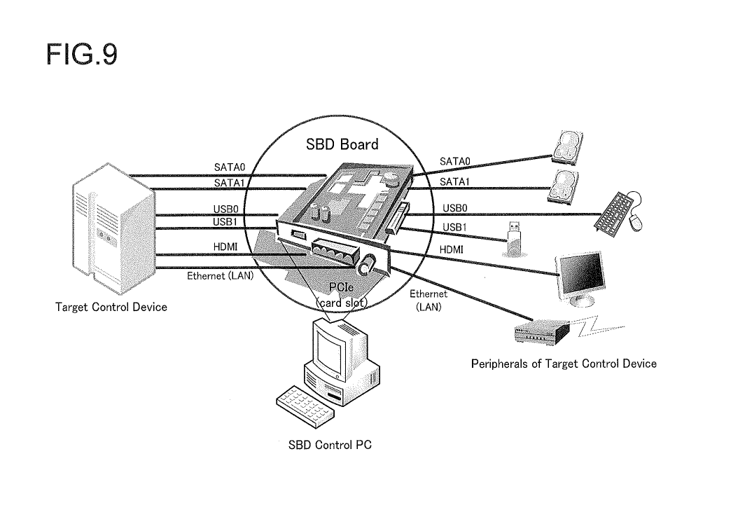

The SBD is, for example, a dedicated FPGA board having the following specs. An FPGA is used in order to perform processing of many ports with a small delay. In order to implement handling of a file system and a user interface, the SBD can be connected to a SBD control (host) PC by pci-e. Within a range that the board size permits, many ports for protection targets are mounted. A conceivable connection example is illustrated in FIG. 9. In applications in which downsizing is critical, the configuration can be replaced by USB connection to a smaller SBD control PC or an FPGA softcore processor can be alternatively used. In such a case, a keyboard and a display of a protection-target device are used in a switching manner by the FPGA, and the SBD directly issues an alert to the user terminal or a request to input a password. Also, a log regarding individual IOs is recorded, and, when security violation occurs, the log is utilized to determine the cause.

Board size: PCI Express card shape

FPGA chip: Xilinx Kintex-7 676 pins (XC7K325T)

Flash ROM for configuration: For writing a circuit to the FPGA at the time of power-on

Memory I/F: DDR3 SODIMM×1

Video input: HDMI×1 (without copy control HDCP)

Video output: HDMI×1 (without copy control HDCP)

Storage I/F: SATA (7 pins)×4/5 (SATA 3.0)

Communication I/F: 1 G/100 M-bit Ethernet (RJ-45)×2

General-purpose I/F: USB (Type A)×6 (USB 2.0)

SBD control PC I/F: PCI Express×1

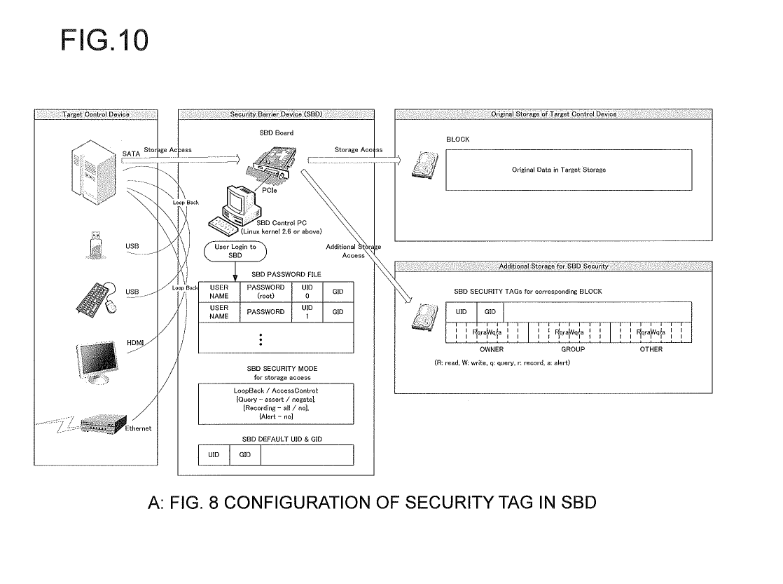

FIG. 10 illustrates the configuration of a security tag recorded in the security additional disk of the SBD. By logging into the SBD and making a configuration, access control different from user to user can be performed. The configuration is temporarily made such that data from ports other than the SATA port passes through (via the FPGA).

The following is a summary of the embodiment of the present invention described above.

As means for specifying security such as write prohibition/write inquiry/read prohibition/read inquiry for data of a given size and a given number of pieces of data, a storage component for holding security information is prepared in addition to a storage component for holding data. For each unit of storage of the storage component for holding data, corresponding security information is held in the storage component for security information. In response to occurrence of a request to access data, security information corresponding to a storage area for holding the data is referred to, and an operation is performed in accordance with the security information. Alternatively, as another implementation method, the storage component for holding data is also used as the storage component for holding security information instead of preparing the storage component for holding security information separately from the storage component for holding data. Specifically, a portion of a storage area of the storage component for holding data is not used as a data area and is set as an area invisible from the user, and the security information may be held in the area.

As for an access violation notification and an access permission inquiry to the user, IO ports used therefor are connected to the PC via a unique apparatus of the present invention, just like the storage. This allows the apparatus to directly make a notification or inquiry regarding IO of secure data using a display or touch panel usually used, independently of the PC side. Accordingly, no additional IO devices are needed.

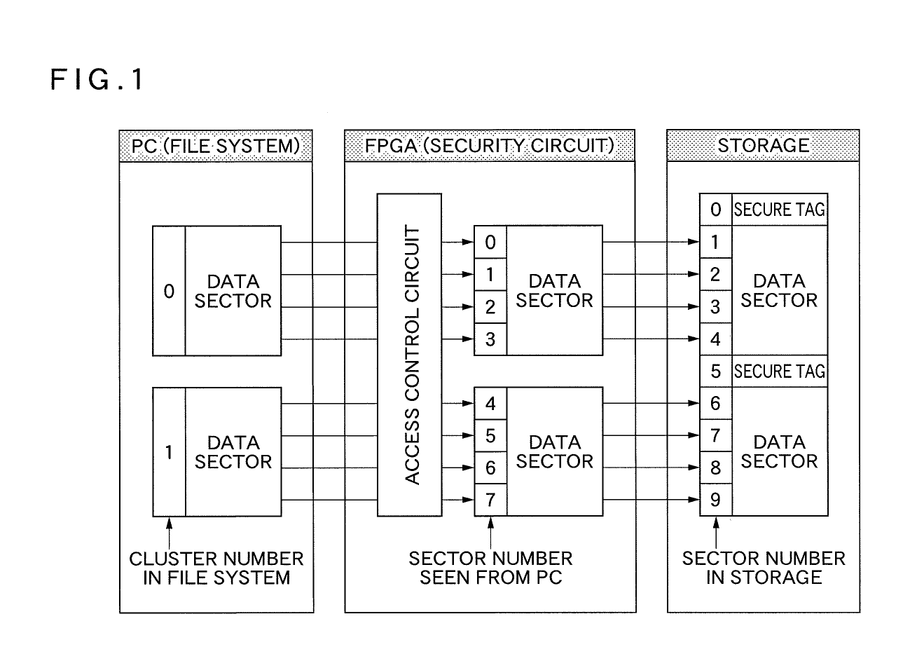

As an example of a data-protection-function-equipped storage apparatus (secure data storage apparatus) according to a first embodiment of the present invention, the case where a storage such as a hard disk that performs access in units of sectors is used as the storage component and the data area and the security information area are allocated in the same storage is illustrated in FIG. 1. The PC is connected to an FPGA (chip in which a logic circuit has been written) instead of the hard disk. In response to data access, the circuit on the FPGA refers to the security information of the secure tag, and performs write prohibition or read prohibition processing. Although not illustrated in the figure, in the case where an IO for the user is connected to the FPGA, an inquiry may be made to the user as to whether or not to permit data access using it. In the figure, a cluster of the file system visible from the PC is composed of four data sectors. This is the same as the case of directly using an ordinary hard disk or the like, and it is impossible to determine whether or not the protection function is provided from the PC side. Control of the secure tag and access protection is performed by a security circuit of the FPGA, and cannot be performed from the PC.

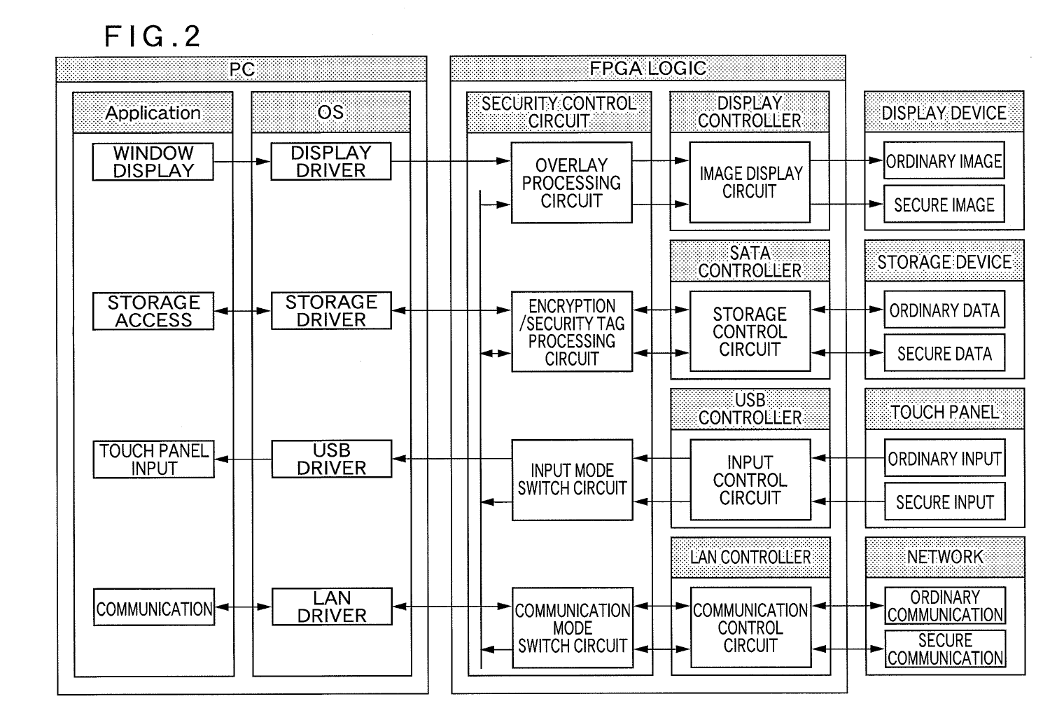

As an expansion example of a data-protection-function-equipped storage apparatus (secure data storage apparatus) according to a second embodiment of the present invention, a method for implementing secure access to a display, a touch panel, and a network as well as the storage is illustrated in FIG. 2. These storage, display, touch panel, and network appear to be the same as the ordinary ones without the protection function from the OS or program on the PC. However, as for access to these, the circuit on the FPGA discriminates between ordinary access and secure access. In this way, secure data can be exchanged without via the OS or application program. For example, occurrence of access violating data protection may be directly displayed on the user's display, permission to access the data may be made to the user, and a data protection setting may be changed directly from the circuit on the FPGA. As for communication, the FPGA can perform direct secure communication independently of general communication, and thus coordination between a plurality of apparatuses of the present invention, exchange of secure data, and so on can be performed.

While the embodiments of the present invention have been described in detail above, the present invention is not limited to the embodiments above. Various design alterations can be made to the present invention as long as such alterations do not deviate from matters described in the claims. Because the SBD is a hardware device, the SBD is not detectable by malware. By analyzing the TO log in response to detection of unauthorized access to data, the SBD is useful to discover malware of new type. A storage rollback function can also be implemented. Communication security can also be implemented. Further, applications in various circumstances, such as an experiment of a display device of new type, are expected.

1. A secure data storage apparatus, wherein
the secure data storage apparatus is capable of setting a specified data area to be a write-prohibited data area, and in a case where there is a write request for the write-prohibited data area, does not perform writing in the area, and that information about the request is recorded and a user is notified that the request has been prohibited.

2. The secure data storage apparatus according to claim 1, wherein
the secure data storage apparatus is capable of setting a specified data area to be a read-prohibited data area, and in a case where there is a read request for the read-prohibited data area, does not perform reading in the area, and that dummy data is returned, information about the request is recorded, and a user is notified that the request has been prohibited.

3. The secure data storage apparatus according to claim 1, wherein
the secure data storage apparatus is capable of setting a specified data area to be subjected to a write inquiry or read inquiry, and has a function of making an inquiry to a user as to whether or not to permit writing or reading in a case where there is a write request or read request for the data area, and of performing writing or reading only in a case where permission is returned.

4. The secure data storage apparatus according to claim 1, comprising
as means for specifying security of write prohibition/write inquiry/read prohibition/read inquiry for a given number of storage areas or a storage area of a given size, a storage component for holding security information in addition to a storage component for holding data, wherein for each unit of storage of the storage component for holding data, corresponding security information is held in the storage component for holding security information, and in a case where a request to access the data occurs, the secure data storage apparatus refers to the security information corresponding to a storage area for storing the data and operates in accordance with the security information.

5. The secure data storage apparatus according to claim 4, wherein
the storage component for holding data is also used as the storage component for holding security information, a portion of a storage area of the storage component for holding data is an area that is not used as a data area and is invisible from a user, and the security information is held in the area.

6. A secure IO apparatus according to claim 1, wherein
various IO ports are directly controlled by hardware so that the control is not sensed from an OS or application program on a PC and IO of data is performed in a secure manner.
